(19) United States
(12) Patent Application Publication
(10) Pub. No.: US 2005/0012683 A1
(43) Pub. Date: Jan. 20, 2005

(54) Spectacle with data receiving and projecting device

(76) Inventor: Yu-Yu Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/618,648

(22) Filed: Jul. 15, 2003

(51) Int. Cl. G09G 5/00

(52) U.S. Cl. 345/8

(57) ABSTRACT

A spectacle with a data receiving and projecting device includes a data display unit for displaying a data from a data generating circuit. A light emitting device is disposed at the rear part of the data display unit, generating a light and projecting the data displayed on the data display unit onto the spectacle lenses. Preferably, one or more focusing lens is mounted for generating a clear image. A wireless signal receiving module is mounted in the spectacle for receiving GPS positioning signal and/or heartbeat signal. The wireless signal receiving module transmits the received signals to a decoder and a micro-controller for decoding and processing, and drives the data display unit to display the data via a driving circuit. A reflective mirror is disposed to modify the spatial arrangement of the optic components.

### BACKGROUND OF THE INVENTION

1. Field of the Invention

The present invention relates to a data displaying device, and more particularly to a spectacle with a data receiving and projecting device capable of receiving a data and projecting an image data onto a user's eye.

2. Description of the Prior Art

Visual display devices which present scene and/or data information have been readily available since the invention of the television. Display devices have been broadly applied for a broad spectrum of applications, such as televisions, image projecting systems, computer screens and aircraft data displaying systems. Currently, visual display is one of the most important devices that can provide a direct communication between man and machine.

Personal displays are designed to be viewed by a single viewer, such as Heads-Up Displays (HUDs) in aircraft applications. Such personal displays have only begun to reach maturity recently, and are used by a relatively small section of the general public.

The common liquid crystal display is designed in the form of a spectacle, which is used mainly in the area of medical treatment, military, entertainment and so on. Principally, an image data e.g. in television tuner is digitized by a high resolution Liquid Crystal Display (LCD Display) and Liquid Crystal Driver (LCD Driver), and then displayed on the Liquid Crystal Display on the lens of the spectacle by means of a display interface. However, such a display device is very expensive. Moreover, due to the characteristics of liquid crystal, such display device is restricted to be used in mild temperature. It cannot function normally when the ambient temperature is extremely high or low, e.g. at outdoor activity in sun shining or snowing day.

### SUMMARY OF THE INVENTION

The primary object of the present invention is to provide a spectacle with data receiving and projecting device, which is capable of projecting a data image onto a user's eye.

Another object of the present invention is to provide a spectacle with a Liquid Crystal Display (LCD Display). A data generated by a data generating circuit is displayed on the LCD display. The data is then projected by light to a user's eye.

A further object of the present invention is to provide a spectacle with data receiving and projecting device, which comprises a rack on which a LCD display is mounted. The rack is rotatably connected via a pivot joint to a frame of the spectacle so that the LCD display is positioned manually on or away from the spectacle. The user can readily view data transmitted from the LCD display through a focusing lens onto the user's eye.

A still further object of the present invention is to provide a spectacle with data receiving and projecting device, which is capable of displaying exerciser's body signals. The data displaying spectacle comprises a data generating circuit which comprises a wireless signal receiving module capable of receiving a signal emitted from a Global Satellite Positioning System and a heartbeat signal from a heartbeat sensing device. Thereby, a user can simultaneously monitor his body signals transmitted wirelessly to the spectacle at exercise.

To achieve the above and other objects, the spectacle with data receiving and projecting device of the present invention comprises a data projecting module, a circuit board and a wireless signal receiving module embedded in the recesses of a frame. The data projecting module comprises a light emitting device, a first focusing lens, a data display unit, a second focusing lens and a third focusing lens arranged in a sequence. The light emitting device generates a light and projects through the first focusing lens to the data display unit. The circuit board comprises a data generating circuit which generates and transmits data to the data display unit. The light from the first focusing lens then projects the data on the data display unit through a second focusing lens to a display region of the spectacle lens. The display region is coated with reflective material and reflects the light through a third focusing lens to the user's eye. A reflective mirror may be disposed between the first focusing lens and the data display unit for modifying the spatial arrangement of components in the dam projecting module. In another embodiment, the spectacle comprises a rack on which a LCD display which is mounted. The rack is rotatably connected via a pivot joint to the frame of spectacle. The data from the data generating circuit are directly displayed on the LCD display, and projected through a focusing lens to the user's eye.

By means of the data generating circuit, the signal from a Global Satellite Positioning System or a heartbeat signal from a heartbeat sensing device are received by a wireless signal receiving circuit, and forwarded to a decoder for decoding and to a micro-controller for calculating and processing the positioning signal, and then generates data including the positioning, moving speed, altitude, heartbeat and so on of the user.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective rear view of a spectacle with data receiving and projecting device in accordance with the present invention;

FIG. 2 is an exploded schematic view showing the arrangement of the components of a data projecting module of the spectacle with data receiving and projecting device in accordance with a first embodiment of the present invention;

FIG. 3 shows an equivalent optic path of the optical system of the first embodiment of the present invention;

FIG. 4 is an exploded schematic view showing the arrangement of the components of the data projecting module of the spectacle with data receiving and projecting device in accordance with a second embodiment of the present invention;

FIG. 5 is a circuit block diagram showing the connection between the data generating circuit and the optical system of FIG. 3 of the present invention;

FIG. 6 shows that a data receiving and projecting device is mounted on a spectacle at a first position in accordance with a third embodiment of the present invention;

FIG. 7 shows that the data receiving and projecting device of FIG. 6 is mounted on the spectacle at a second position; and

FIG. 8 is a block diagram showing the connection between the data generating circuit of the circuit board and the data projecting module of the spectacle with data receiving and projecting device in accordance with the third embodiment of the present invention.

### DETAILED DESCRIPTION OF THE PREFERRED EMBODIMENTS

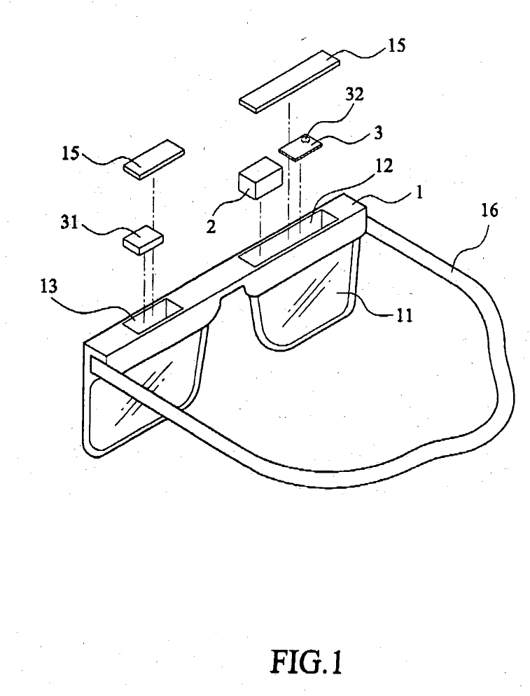

With reference to the drawings and in particular to FIG. 1, a spectacle with data receiving and projecting device in accordance with the present invention is shown. The spectacle comprises a frame 1 and a pair of lenses 11. Two recesses 12, 13 respectively located on the frame 1. The right recess 12 is disposed with a data projecting module 2 and a circuit board 3. The circuit board 3 is mounted with a battery 32 for supplying power. A wireless signal receiving module 31 is mounted in the left recess 13 for receiving wireless signals, such as Global Satellite Positioning System (GPS) signal and heartbeat signal of a user. Two covers 15 are provided respectively at the top of the recesses 12, 13 for securing the data projecting module 2 and the circuit board 3 and the wireless signal receiving module 31 in the recesses 12, 13. The two ends of the frame 1 are connected with an elastic belt 16 for securing the spectacle on the user's head.

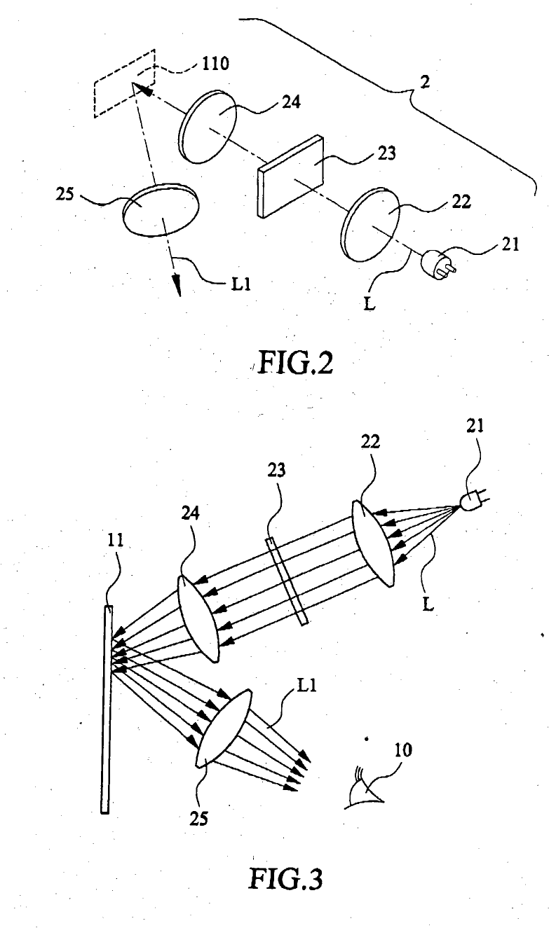

Please refer to FIG. 2 which shows the arrangement of the components of the data projecting module shown in FIG. 1 in accordance with a first embodiment of the present invention. The data projecting module 2 comprises a light emitting device 21, a first focusing lens 22, a data display unit 23, a second focusing lens 24 and a third focusing lens 25 arranged in a sequence. The focusing lenses 22, 24 and 25 are capable of focusing the light projected thereon.

The circuit board 3 comprises a data generating circuit which will be discussed hereinafter. The data generating circuit is capable of generating a data which is displayed in the data display unit 23 via a driving circuit.

The light emitting device 21 comprises at least one light-emitting diode (LED) or light projecting element for generating a light L. The light L is projected through the first focusing lens 22 to the data display unit 23. A data is generated by the data generating circuit and displayed on the data display unit 23. The light L projects the data on data display unit 23 through the second focusing lens 24 to a display region 110 of the spectacle lens 11.

The display region 110 is defined on the rear surface and at an upper part of the lens 11. Further, the display region 110 is coated with a reflective material thereon, enabling the lens 11 to reflect the data, while the lower part of the lens 11 is fully transparent, enabling the user to view the surrounding. The data is reflected and transmitted as optical light L1 though the third focusing lens 25 to the user's eye. Accordingly, when the user looks up, he can view data showing on the display region 110, and when he looks forward or looks down, he can see the surrounding.

The data display unit 23 may be a Liquid Crystal Display (LCD) which displays input data by means of liquid crystal and is characterized in that the displaying data is pervious to light.

In the arrangement of the mentioned optic components, the light L is generated from the light emitting device 21, transmitted through the data display unit 23, reflected by the lens 11 and projected on the user's eye. If the clarity of the image projected on the user's eye is within an acceptable range, the first, second and third focusing lens 22, 24 and 25 may be omitted. In other words, if the arrangement of the light emitting device 21, the data display unit 23 and the lens 11 enables the generation of a clear image on the lens 11, no focusing lens is required.

With reference to FIG. 3 which shows an equivalent optic path of the optical system of the present invention. The light emitting device 21 generates the light L which is then transmitted through the first focusing lens 22 and projected to the data display unit 23. Thereby, the data shown on the data display unit 23 is projected by light L through the second focusing lens 24 onto the display region 110 of lens 11. Light L is then reflected by lens 11 and projected through the third focusing lens 25 and falls on the user's eye 10 as light L1.

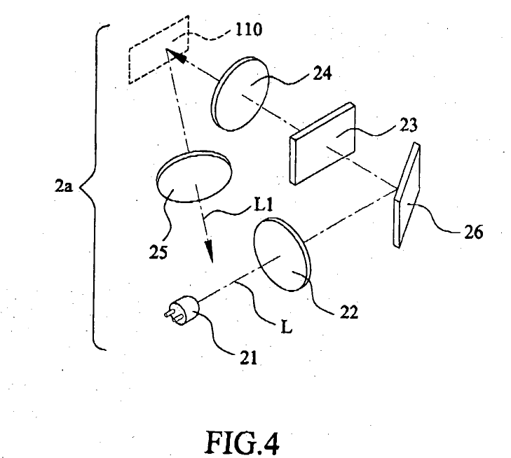

Please refer to FIG. 4. FIG. 4 is an exploded schematic view of the data projecting module of the spectacle with data receiving and projecting device in accordance with a second embodiment of the present invention. The data projecting module 2a comprises a light emitting device 21, a first focusing lens 22, a data display unit 23, a second focusing lens 24, a third focusing lens 25 and a reflective mirror 26 disposed between the first focusing lens 22 and the data display unit 23, all the components arranged in a sequence. In the embodiment, both the data display unit 23, second focusing lens 24 and lens 11 are aligned in a line perpendicular to the light emitting device 21 and first focusing lens 22. By using th e reflective mirror 26, light L is reflected and transmitted from the first focusing lens 22 to the data display unit 23. The installation of the reflective mirror 26 and any similar optic components enables the modification of the spatial arrangement of the components in the data projecting module 2, so as to provide a more compact and practical design. Of course, to those who skilled in the arts, other optic components can be used to provide a more compact and practical configuration. All the other components are the same as in the first embodiment.

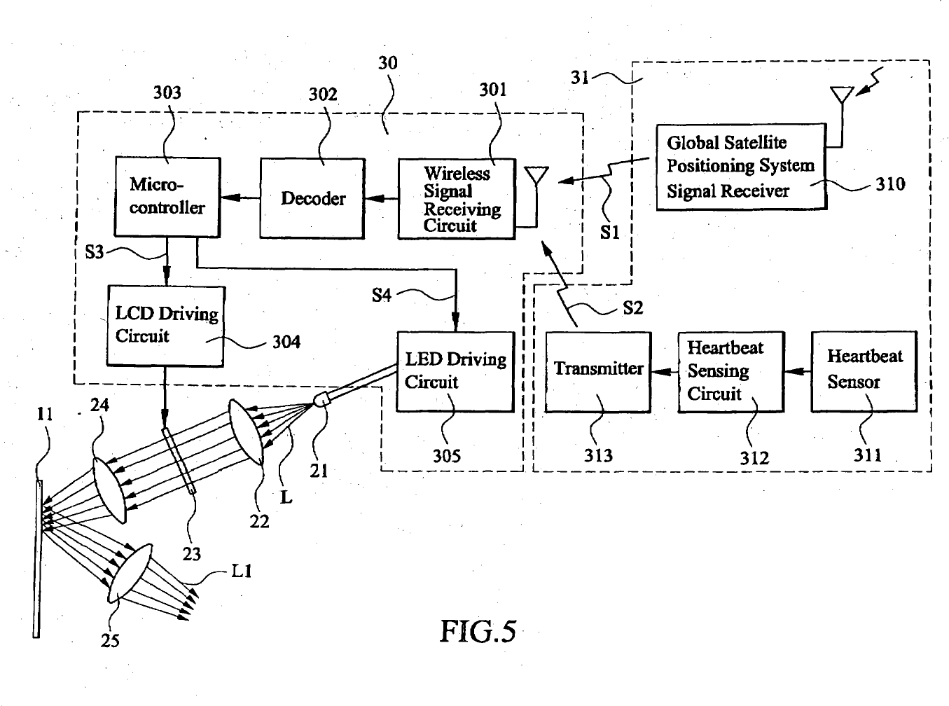

FIG. 5 is a circuit block diagram showing the connection between the data generating circuit and the optical system of FIG. 3 of the present invention. The data generating circuit 30 comprises a wireless signal receiving circuit 301, a decoder 302, a micro-controller 303, a LCD driving circuit 304 and a LED driving circuit 305.

The wireless signal receiving circuit 301 is capable of receiving a wireless transmitted signal, such as GPS positioning signal or a heartbeat signal. The wireless signal receiving module 31 of FIG. 1 may include a Global Satellite Positioning System (GPS) signal receiver 310 capable of receiving a positioning signal emitted from a Global Satellite Positioning System and emits a positioning signal S1 to the wireless signal receiving circuit 301. The wireless signal receiving module 31 may also include a known heartbeat sensing device comprises a heartbeat sensor 311, a heartbeat sensing circuit 312 and a transmitter 313. The heartbeat sensor 311 detects the user's heartbeat and then generates a heartbeat pulse signal to the heartbeat sensing circuit 312 for amplifying, processing and shaping. A signal is then forwarded to the transmitter 313 and a heartbeat signal S2 is emitted out wirelessly.

After receiving the GPS positioning signal S1 generated by the Global Positioning System signal receiver 310 and/or the heartbeat signal S2 generated by the heartbeat sensing device, the signals are then forwarded to a decoder 302 for decoding and to a micro-controller 303 for processing. For example, when receiving a GPS positioning signal, the micro-controller 303 calculates and processes the positioning signal, and then generates data including the positioning, moving speed, altitude and other information of the user. When receiving a heartbeat signal, the micro-controller 303 calculates and processes the heartbeat signal, and then generates a heartbeat data of the user.

The processed signal S3 from the micro-controller 303 is forwarded to a Liquid Crystal Display (LCD) driving circuit 304 which drives the data display unit 23 to display the data. A signal S4 is also transmitted from the micro-controller 303 to a LED driving circuit 305 which drives the light emitting device 21 to generate a light L.

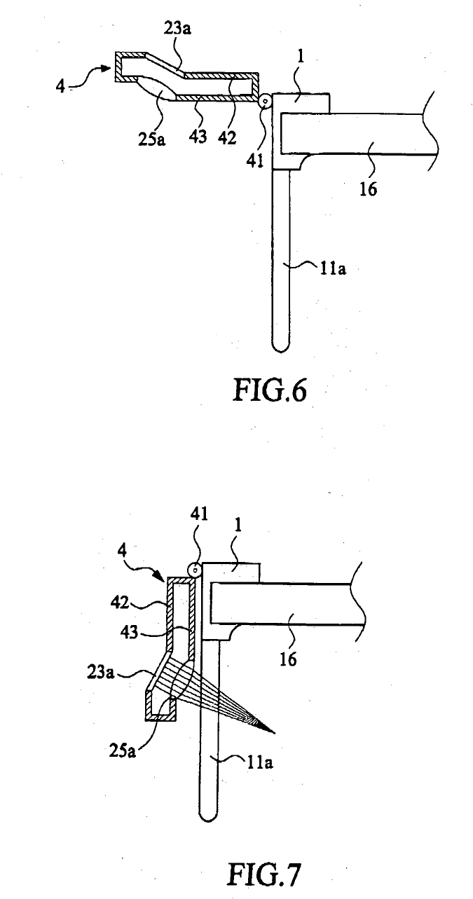

FIG. 6 shows that a data receiving and projecting device is mounted on a spectacle at a first position in accordance with a third embodiment of the present invention. FIG. 7 shows that the data receiving and projecting device of FIG. 6 is mounted on the spectacle at a second position. Except the data projecting module and lenses, all the other optic components are identical to that of the first embodiment. In the embodiment, the lenses 11a are not coated with reflective material and are fully transparent. Moreover, the data projecting module comprises a LCD display 23a and a focusing lens 25a.

The data receiving and projecting device of the third embodiment of the present invention comprises a rack 4 removably and rotatably connected via a pivot joint 41 to the front edge of the frame 1. The rack 4 comprises two plates 42, 43 which are parallel and bends outwardly at the ends, on which the LCD display 23a and focusing lens 25a are respectively disposed. The LCD display 23a is mounted near the end of the front plate 42, while the focusing lens 25a is mounted near the end of the rear plate 43 corresponding to the LCD display 23a. LCD display 23a displays input data by means of liquid crystal and is characterized in that the displaying data is pervious to light. The focusing lens 25a is capable to focus the image from the LCD display 23a onto the user's eye. Both the LCD display 23a and the focusing lens 25a are positioned in correspondence to a display region defined on the front surface of the lens 11a. Accordingly, the light from the LCD display 23a projects through the focusing lens 25a to the user's eyes.

The rack 4 is rotatable about the pivot point 41 and can be turned to align in parallel with the lens 11a or incline upwardly. When used, the rack 4 is turned downwardly so that the LCD display 23a is aligned in parallel and overlapped on the lens 11a. Thereby, the user can directly view the data displayed on the LCD display 23a through the focusing lens 25a. When not in use, the rack 4 is turned upwardly such that the LCD display 23a is turned to orient e.g. perpendicular to the lens 11a or incline upwardly, so that the user can take a whole view of the surrounding. Of course, the user is able to view the surrounding through the lens 11a even if the rack 4 is not turned upwardly. Also, the frame 1 comprises an elastic belt 16 for securing to the user's head.

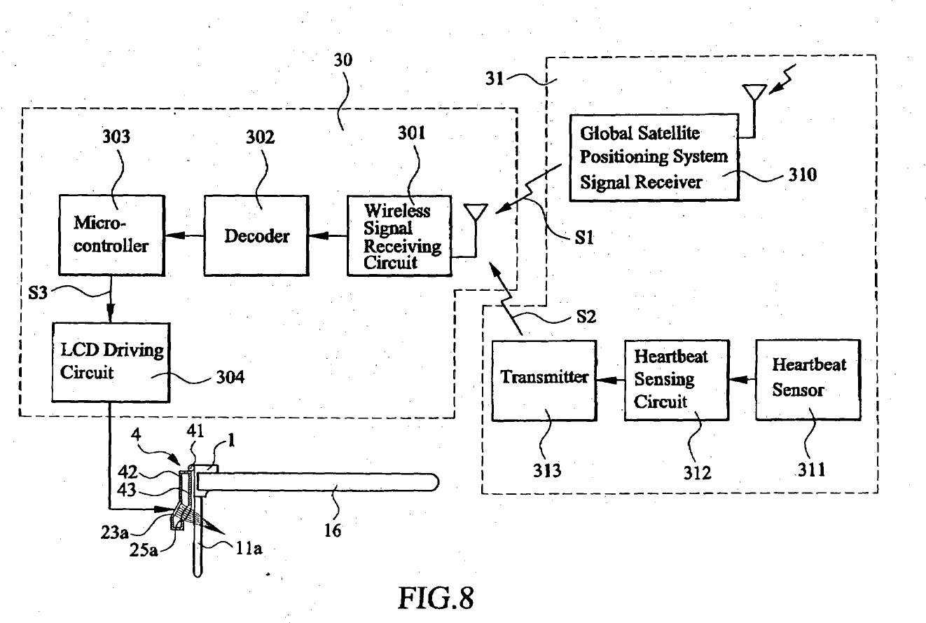

FIG. 8 is a circuit block diagram showing the connection between the data generating circuit and the optical system of FIG. 7 of the present invention. The GPS positioning signal S1 generated by a GPS signal receiver 310 and the heartbeat signal S2 generated by a heartbeat sensing device are transmitted to and received by a wireless signal receiving circuit 301. The signals are then forwarded to a decoder 302 for decoding and to a micro-controller 303 for processing. The processed signal S3 including the positioning, moving speed, altitude and/or heartbeat of the user is forwarded from the micro-controller 303 to a Liquid Crystal Display. (LCD) driving circuit 304 which drives the LCD display 23a to display the data. Accordingly, the user can view the data displayed on the LCD display 23a through the focusing lens 25a.

Although the present invention has been described with reference to the preferred embodiments thereof, it is apparent to those skilled in the art that a variety of modifications and changes may be made without departing from the scope of the present invention which is intended to be defined by the appended claims.

1. A spectacle, comprising:
at least one lens mounted on the spectacle, a display region being defined on a rear surface of the lens;
a data generating circuit for generating at least one data to be displayed;
a data display unit adjacent to the display region of the lens, for receiving and displaying the data generated by the data generating circuit; and
a data projecting module mounted in the spectacle for projecting the data displayed on the data display unit onto the display region of the lens.

2. The spectacle as claimed in claim 1, wherein the data display unit is a Liquid Crystal Display.

3. The spectacle as claimed in claim 1, wherein the data projecting module comprises a light emitting device disposed behind the data display unit, for generating a light projecting to the data display unit and thereby projecting the data displayed on the data display unit onto the display region of the lens.

4. The spectacle as claimed in claim 3, the data projecting module further comprising at least one first focusing lens disposed between the light emitting device and the data display unit.

5. The spectacle as claimed in claim 3, the data projecting module further comprising at least one second focusing lens disposed between the data display unit and the display region of the lens.

6. The spectacle as claimed in claim 3, the data projecting module further comprising at least one third focusing lens disposed between the display region of the lens and a user eyes.

7. The spectacle as claimed in claim 3, the data projecting module further comprising at least one reflective mirror disposed between the light emitting device and the data display unit for reflecting the light generated by the light emitting device onto the data display unit.

8. The spectacle as claimed in claim 3, wherein the light emitting device comprises a light-emitting diode.

9. The spectacle as claimed in claim 1, further comprising a wireless signal receiving module coupled to the data generating circuit, the wireless signal receiving module receiving at least one wireless signal and then transmitting the received wireless signal to the data generating circuit.

10. The spectacle as claimed in claim 9, wherein the wireless signal receiving module comprises a Global Satellite Positioning System signal receiver.

11. The spectacle as claimed in claim 9, wherein the wireless signal receiving module comprises a heartbeat sensing device.

12. The spectacle as claimed in claim 1, the display region being further coated with a reflective material for reflecting the light projected from the data projecting module.

13. A spectacle, comprising:
at least one lens mounted on the spectacle, a display region being defined on a front surface of the lens;
a rack pivotally mounted on the spectacle;
a data generating circuit for generating at least one data to be displayed; and
a data display unit mounted on the rack and adjacent to the display region of the lens, for receiving and displaying the data generated by the data generating circuit;
wherein the data displayed on the data display unit is projected to a user's eyes through the display region of the lens.

14. The spectacle as claimed in claim 13, further comprising a focusing lens mounted on the rack and disposed between the data display unit and the display region of the lens.

15. The spectacle as claimed in claim 13, wherein the rack is pivotally connected on the spectacle by a pivot point, so that the rack is rotatable about the pivot point.

16. The spectacle as claimed in claim 13, wherein the data display unit is a Liquid Crystal Display.

17. The spectacle as claimed in claim 13, further comprising a wireless signal receiving module coupled to the data generating circuit, the wireless signal receiving module receiving at least one wireless signal and then transmitting the received wireless signal to the data generating circuit.

18. The spectacle as claimed in claim 17, wherein the wireless signal receiving module comprises a Global Satellite Positioning System signal receiver.

19. The spectacle as claimed in claim 17, wherein the wireless signal receiving module comprises a heartbeat sensing device.
